(19) United States
(12) Patent Application Publication
(10) Pub. No.: US 2026/0074108 A1
(43) Pub. Date: Mar. 12, 2026

(54) MULTILAYER ELECTRONIC COMPONENT

(71) Applicant: SAMSUNG ELECTRO-MECHANICS CO., LTD., Suwon-si (KR)

(72) Inventors: Seung Yeon LEE, Suwon-si (KR); Woo Jin LEE, Suwon-si (KR); Berm Ha CHA, Suwon-si (KR)

(73) Assignee: SAMSUNG ELECTRO-MECHANICS CO., LTD., Suwon-si (KR)

(21) Appl. No.: 19/088,050

(22) Filed: Mar. 24, 2025

(30) Foreign Application Priority Data
Sep. 11, 2024 (KR) 10-2024-0123749

(51) Int. Cl. H01G 4/005; H01G 4/30

(52) U.S. Cl. CPC H01G 4/005; H01G 4/30

(57) ABSTRACT

A multilayer electronic component includes a body including dielectric layers and internal electrodes disposed alternately in a first direction, and an external electrode disposed on respective surfaces of the body opposing each other in a second direction that is perpendicular to the first direction. The body includes dummy electrodes disposed to be spaced apart from the internal electrodes in a third direction that is perpendicular to the first direction and the second direction. When a distance in the first direction from an uppermost internal electrode in the first direction to a lowermost internal electrode in the first direction is denoted by A, and a distance in the first direction from an uppermost dummy electrode in the first direction to a lowermost dummy electrode in the first direction is denoted by a, a/A satisfies 0.30 or more and 0.80 or less.

### CROSS-REFERENCE TO RELATED APPLICATION(S)

This application claims benefit of priority to Korean Patent Application No. 10-2024-0123749 filed on Sep. 11, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

A body of a multilayer electronic component may include a margin portion in which an internal electrode is not formed in a width direction of the body, and a cover portion in which the internal electrode is not formed in a thickness direction of the body. A step portion may be formed between the margin portion, in which the internal electrode is not formed, and a capacitance formation portion, a region overlapping the internal electrode in the thickness direction, due to the presence or absence of the internal electrode. The step portion between the capacitance formation portion and the margin portion may cause stress imbalance in the process of pressing and sintering the internal electrode and a dielectric layer to form the body.

In particular, due to stress imbalance occurring in the process of sintering the body, the cover portion may form a convex portion, and the margin portion may form a concave portion, resulting in cracks occurring at a boundary between the cover portion and the margin portion.

Accordingly, there is a need for a method for alleviating cracks occurring at the boundary between the cover portion and the margin portion and for improving a shape of the multilayer electronic component.

### SUMMARY

An aspect of the present disclosure is to alleviate cracks occurring in a multilayer electronic component due to uneven stress being applied to each of a capacitance formation portion, a margin portion, and a cover portion, when an internal electrode is not formed in the margin portion.

However, the aspects of the present disclosure are not limited to those set forth herein, and will be more easily understood in the course of describing specific example embodiments of the present disclosure.

According to an aspect of the present disclosure, there is provided a multilayer electronic component including a body including a plurality of dielectric layers and a plurality of internal electrodes disposed alternately in a first direction, and an external electrode disposed on respective surfaces of the body opposing each other in a second direction that is perpendicular to the first direction. The body may include a plurality of dummy electrodes disposed to be spaced apart from the internal electrode in a third direction that is perpendicular to the first direction and the second direction. When a distance in the first direction from an uppermost internal electrode in the first direction to a lowermost internal electrode in the first direction is denoted by A, and a distance in the first direction from an uppermost dummy electrode in the first direction to a lowermost dummy electrode in the first direction is denoted by a, a/A may satisfy 0.30 or more and 0.80 or less.

According to example embodiments of the present disclosure, a dummy electrode may be disposed on a margin portion in a width direction, and a region and range in which the dummy electrode is disposed may be adjusted, thereby alleviating cracks occurring in a multilayer electronic component.

However, the various and beneficial advantages and effects of the present disclosure are not restricted to those set forth herein, and will be more easily understood in the process of describing specific example embodiments.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view of FIG. 1, taken along line I-I′;

FIG. 3 is a schematic cross-sectional view of a multilayer electronic component according to a comparative example corresponding to a schematic cross-sectional view of FIG. 1, taken along line II-II′;

FIG. 4 is a schematic cross-sectional view of a multilayer electronic component according to an example embodiment corresponding to a schematic cross-sectional view of FIG. 1, taken along line II-II′;

FIG. 5 is a schematic cross-sectional view of a multilayer electronic component according to an example embodiment corresponding to a schematic cross-sectional view of FIG. 1, taken along line II-II′;

FIG. 6 is a schematic cross-sectional view of a multilayer electronic component according to an example embodiment corresponding to a schematic cross-sectional view of FIG. 1, taken along line II-II′;

FIG. 7 is a schematic cross-sectional view of a multilayer electronic component according to an example embodiment corresponding to a schematic cross-sectional view of FIG. 1, taken along line II-II′;

FIG. 8 is a schematic cross-sectional view of a multilayer electronic component according to an example embodiment corresponding to a schematic cross-sectional view of FIG. 1, taken along line II-II′; and

FIG. 9 is a schematic exploded perspective view of structure of a body of a multilayer electronic component according to an example embodiment.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction may be defined as a direction or thickness direction in which first and second internal electrodes are disposed alternately with a dielectric layer interposed therebetween. Among second and third directions, perpendicular to the first direction, the second direction may be defined as a length direction and the third direction may be defined as a width direction.

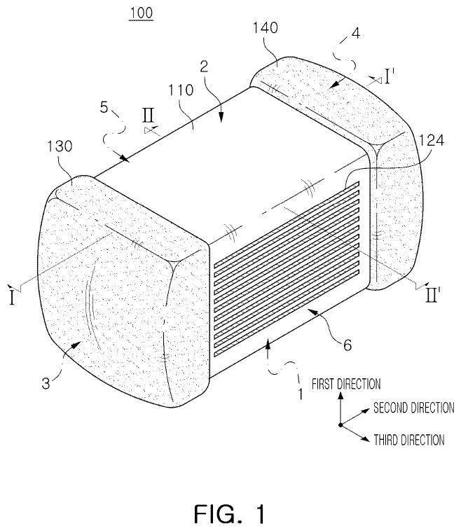

FIG. 1 is a schematic perspective view of a multilayer electronic component according to an example embodiment of the present disclosure.

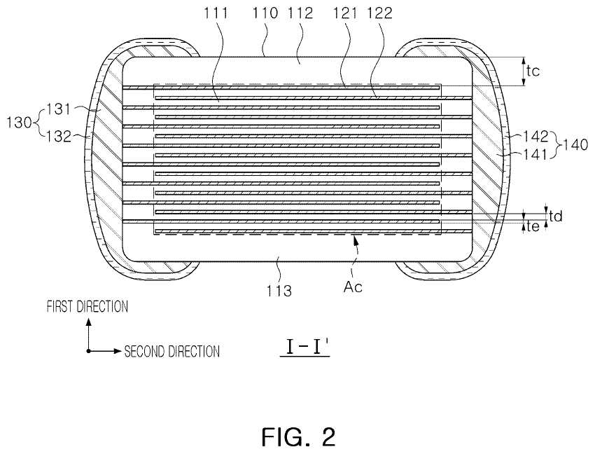

FIG. 2 is a schematic cross-sectional view of FIG. 1, taken along line I-I′.

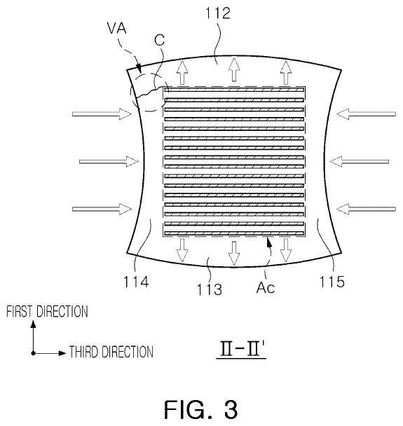

FIG. 3 is a schematic cross-sectional view of a multilayer electronic component according to a comparative example corresponding to a schematic cross-sectional view of FIG. 1, taken along line II-II′.

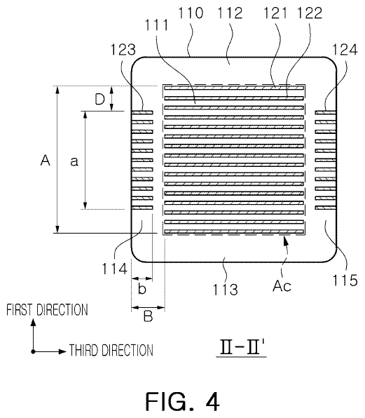

FIG. 4 is a schematic cross-sectional view of a multilayer electronic component according to an example embodiment corresponding to a schematic cross-sectional view of FIG. 1, taken along line II-II′.

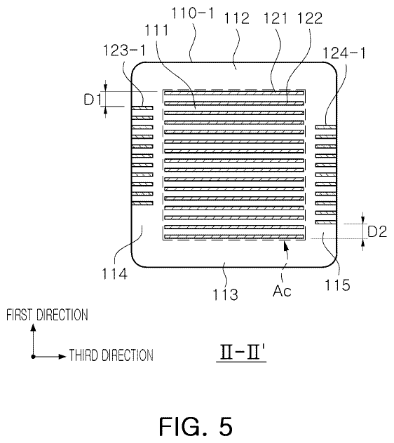

FIG. 5 is a schematic cross-sectional view of a multilayer electronic component according to an example embodiment corresponding to a schematic cross-sectional view of FIG. 1, taken along line II-II′.

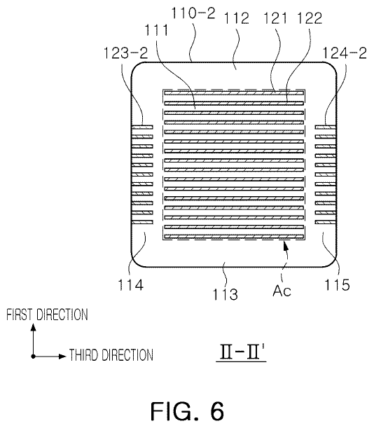

FIG. 6 is a schematic cross-sectional view of a multilayer electronic component according to an example embodiment corresponding to a schematic cross-sectional view of FIG. 1, taken along line II-II′.

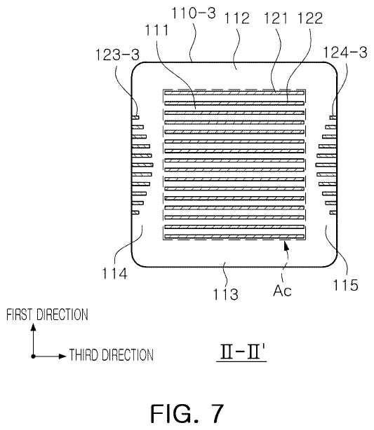

FIG. 7 is a schematic cross-sectional view of a multilayer electronic component according to an example embodiment corresponding to a schematic cross-sectional view of FIG. 1, taken along line II-II′.

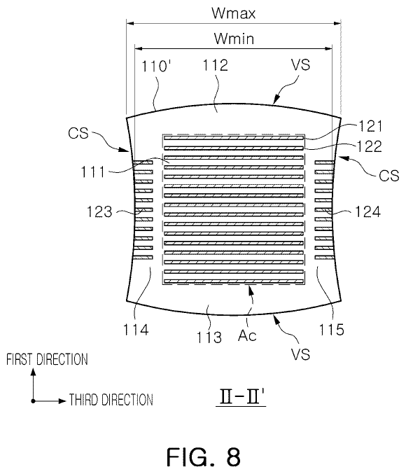

FIG. 8 is a schematic cross-sectional view of a multilayer electronic component according to an example embodiment corresponding to a schematic cross-sectional view of FIG. 1, taken along line II-II′.

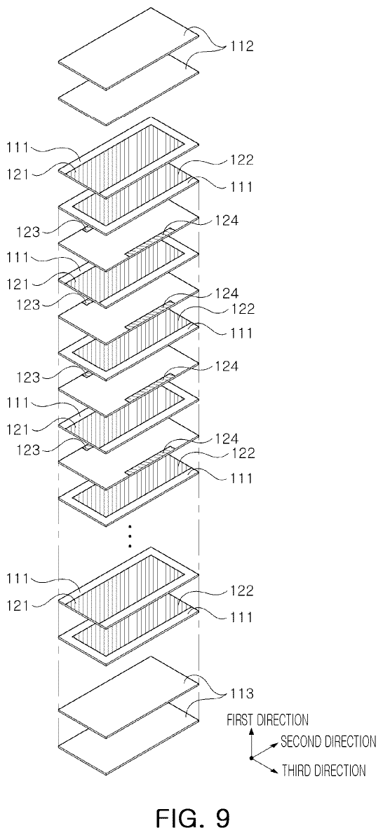

FIG. 9 is a schematic exploded perspective view of structure of a body of a multilayer electronic component according to an example embodiment.

Hereinafter, a multilayer electronic component 100 according to various example embodiments of the present disclosure will be described with reference to FIGS. 1 to 9.

The multilayer electronic component 100 according to an example embodiment of the present disclosure may include a body including dielectric layers 111 and internal electrodes 121 and 122 disposed alternately with the dielectric layers in a first direction, and external electrodes 130 and 140 disposed on surfaces 3 and 4 of the body opposing each other in a second direction that is perpendicular to the first direction. The body may include dummy electrodes 123 and 124 disposed to be spaced apart from the internal electrode in a third direction that is perpendicular to the first direction and the second direction. When a distance in the first direction from an uppermost internal electrode in the first direction to a lowermost internal electrode in the first direction is denoted by A, and a distance in the first direction from an uppermost dummy electrode in the first direction to a lowermost dummy electrode in the first direction is denoted by a, a/A may satisfy 0.30 or more and 0.80 or less.

In the body 110, the dielectric layer 111 and the internal electrodes 121 and 122 may be alternately disposed. Specifically, the first and second internal electrodes 121 and 122 may be alternately disposed with the dielectric layer 111 interposed therebetween. In the present disclosure, a direction in which the dielectric layers 111 and the internal electrodes 121 and 122 are alternately disposed may refer to a first direction.

A specific shape of the body 110 is not limited. However, as illustrated, the body 110 may have a hexahedral shape or a shape similar thereto. During a sintering process, ceramic powder particles, included in the body 110, may contract, such that the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the first to fourth surfaces 1, 2, 3, and 4, the fifth and sixth surfaces 5 and 6 opposing each other in the third direction. In this case, the second direction may refer to a direction, perpendicular to the first direction, and the third direction may refer to a direction, perpendicular to both the first direction and the second direction.

A plurality of dielectric layers 111, included in the body 110, may be in a sintered state, and adjacent dielectric layers 111 may be integrated with each other such that boundaries therebetween are not readily apparent without using a scanning electron microscope (SEM).

According to an aspect of the present disclosure, a raw material, included in the dielectric layer 111, is not limited as long as sufficient capacitance is obtainable therewith. For example, a barium titanate-based material, a lead composite perovskite-based material, or a strontium titanate-based material may be used for the raw material. The barium titanate-based material may include BaTiO₃-based ceramic powder particles, and examples of the ceramic powder particles may include (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃.

In addition, the raw material, included in the dielectric layer 111, may be obtained by adding various ceramic additives, organic solvents, binders, dispersants, or the like to powder particles such as barium titanate (BaTiO₃) depending on the purpose of the present disclosure.

An average thickness (td) of the dielectric layer 111 is not limited. For example, the average thickness (td) of the dielectric layer 111 may be 0.35 μm or less in a small-sized, high-capacitance multilayer electronic component, and the average thickness (td) of the dielectric layer 111 may be 2 μm or more in a multilayer electronic component used at high voltage and high temperature.

The average thickness (td) of the dielectric layer 111 may refer to an average thickness (td) of the dielectric layer 111 disposed between adjacent first and second internal electrodes 121 and 122.

The average thickness (td) of the dielectric layer 111 may be measured by scanning, with an SEM, a cross-section of the body 110 in a length and thickness (L-T) direction at a magnification of 10,000. More specifically, in the scanned image, a thickness of a single dielectric layer 111 may be measured at thirty points equally spaced apart from each other in a length direction, and an average value of the thicknesses of the dielectric layer 111 measured at the thirty equally spaced points may be obtained. The thirty equally spaced points may be designated in a capacitance formation portion Ac. In addition, when such average value measurement is performed on ten dielectric layers 111, an average thickness of the dielectric layer 111 may be further generalized.

The body 110 may include a capacitance formation portion Ac, a region in which the internal electrodes 121 and 122 overlap each other in the first direction. The capacitance formation portion Ac, a portion contributing to forming capacitance of a capacitor, may be formed by repeatedly laminating a plurality of first and second internal electrodes 121 and 122 with the dielectric layer 111 interposed therebetween, and may be a portion contributing to forming capacitance of the capacitor.

The cover portions 112 and 113 may be disposed on one surface and the other surface of the capacitance formation portion Ac in the first direction.

The cover portions 112 and 113 may include an upper cover portion 112 disposed on the one surface of the capacitance formation portion Ac in the first direction, and a lower cover portion 113 disposed on the other surface of the capacitance formation portion Ac in the first direction.

The cover portions 112 and 113 may be formed by laminating a single dielectric layer or two or more dielectric layers on each of upper and lower surfaces of the capacitance formation portion Ac in a thickness direction, and may basically serve to prevent damage to the internal electrode due to physical or chemical stress.

The cover portions 112 and 113 may not include an internal electrode, and may include a material, the same as that of the dielectric layer 111. That is, the cover portions 112 and 113 may include a ceramic material, for example, a barium titanate (BaTiO₃)-based ceramic material.

An average thickness of each of the cover portions 112 and 113 is not limited. For example, in order to more easily achieve miniaturization and high capacitance of the multilayer electronic component, an average thickness (tc) of each of the cover portions 112 and 113 may be 15 μm or less.

The average thickness of each of the cover portions 112 and 113 may refer to a size of each of the cover portions 112 and 113 in the first direction, and may be an average value of sizes of each of the cover portions 112 and 113 in a first direction, measured at several points (e.g., five equally spaced points) of an upper portion or lower portion of the capacitance formation portion Ac.

Margin portions 114 and 115 may be disposed on side surfaces of the capacitance formation portion Ac. That is, regions of the body 110, positioned on both sides of the capacitance formation portion Ac in the third direction, a region in which the internal electrodes 121 and 122 overlap each other in the first direction, may be referred to as the margin portions 114 and 115. In this case, the margin portions 114 and 115 may be divided into a first margin portion 114 positioned on one side of the capacitance formation portion Ac in the third direction, and a second margin portion 115 positioned on a side opposite to the one side of the capacitance formation portion Ac in the third direction.

As illustrated in FIG. 4, the margin portions 114 and 115 may refer to regions between both ends of the first and second internal electrodes 121 and 122 and a boundary surface of the multilayer portion 110 in a cross-section of the multilayer portion 110 in a width-thickness (W-T) direction.

The margin portions 114 and 115 may basically serve to prevent damage to the internal electrodes due to physical or chemical stress.

The margin portions 114 and 115 may be formed by forming an internal electrode by coating a conductive paste on a ceramic green sheet, except for a portion of the ceramic green sheet on which a margin portion is to be formed.

In addition, in order to suppress a step portion caused by the internal electrodes 121 and 122, the internal electrodes 121 and 122 may be laminated and cut to be exposed through the fifth and sixth surfaces 5 and 6 of the body, and then a single dielectric layer 111 or two or more dielectric layers may be laminated on both side surfaces of the capacitance formation portion Ac in the third direction (width direction) to form the margin portions 114 and 115.

A width of each of the margin portions 114 and 115 is not limited. However, in order to more easily achieve miniaturization and high capacitance of the multilayer electronic component, an average width of each of the margin portions 114 and 115 may be 15 μm or less.

The average width of each of the margin portions 114 and 115 may refer to an average size of each of the margin portions 114 and 115 in the third direction, and may be an average value of sizes of the margin portion 114 or 115 in the third direction, measured at five equally spaced points of the side surfaces of the capacitance formation portion Ac.

The internal electrodes 121 and 122 may be disposed alternately with the dielectric layers 111 in the first direction, and may be divided into a first internal electrode 121 (or a plurality of first internal electrodes) and a second internal electrode 122 (or a plurality of second internal electrodes).

The first and second internal electrodes 121 and 122 may be alternately disposed to oppose each other with the dielectric layer 111, included in the body 110, interposed therebetween, and may be connected to the third and fourth surfaces 3 and 4 of the body 110, respectively. Specifically, one end of the first internal electrode 121 may be connected to the third surface, and one end of the second internal electrode 122 may be connected to the fourth surface.

The first internal electrode 121 may be spaced apart from the fourth surface 4 and exposed through the third surface 3, and the second internal electrode 122 may be spaced apart from the third surface 3 and exposed through the fourth surface 4. The first external electrode 130 may be disposed on the third surface 3 of the body to be connected to the first internal electrode 121, and the second external electrode 140 may be disposed on the fourth surface 4 of the body to be connected to the second internal electrode 122.

That is, the first internal electrode 121 may be connected to the first external electrode 130 without being connected to the second external electrode 140, and the second internal electrode 122 may be connected to the second external electrode 140 without being connected the first external electrode 130. Accordingly, the first internal electrode 121 may be formed to be spaced apart from the fourth surface 4 by a predetermined distance, and the second internal electrode 122 may be formed to be spaced apart from the third surface 3 by a predetermined distance. In this case, the first and second internal electrodes 121 and 122 may be electrically isolated from each other by the dielectric layer 111 interposed therebetween.

The body 110 may be formed by alternately laminating a ceramic green sheet on which the first internal electrode 121 is printed, and a ceramic green sheet on which the second internal electrode 122 is printed, and then performing sintering thereon.

A material, included in the internal electrodes 121 and 122, is not limited, and the internal electrodes 121 and 122 may include a conductive metal element. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing, on a ceramic green sheet, an internal electrode conductive paste including at least one of nickel (Ni), copper (Cu), palladium (Pd), silver (Ag), gold (Au), platinum (Pt), tin (Sn), tungsten (W), titanium (Ti), and alloys thereof. A screen-printing method or a gravure-printing method may be used as a method of printing the internal electrode conductive paste, but the present disclosure is not limited thereto.

In addition, an average thickness (te) of each of the internal electrodes 121 and 122 is not limited. For example, the average thickness (te) of each of the internal electrodes 121 and 122 may be 0.35 μm or less in a small-sized, high-capacitance multilayer electronic component, and the average thickness (te) of each of the internal electrodes 121 and 122 may be 2 μm or more in a multilayer electronic component used at high voltage and high temperature.

The average thickness (te) of each of the internal electrodes 121 and 122 may refer to an average thickness (te) of each of the internal electrodes 121 and 122.

The average thickness (te) of each of the internal electrodes 121 and 122 may be measured by scanning, with an SEM, a cross-section of the body 110 in a length and thickness (L-T) direction at a magnification of 10,000. More specifically, in the scanned image, a thickness of a single internal electrode may be measured at multiple (e.g., thirty) points equally spaced apart from each other in the length direction, and an average value of the thicknesses of the internal electrode measured at the multiple (e.g., thirty) equally spaced points may be obtained. The multiple (e.g., thirty) equally spaced points may be designated in the capacitance formation portion Ac. In addition, when such average value measurement is performed on multiple (e.g., ten) internal electrodes, an average thickness of the internal electrodes may be further generalized.

The external electrodes 130 and 140 may be disposed on the third surface 3 and the fourth surface 4 of the body 110. The external electrodes 130 and 140 may include first and second external electrodes 130 and 140 respectively disposed on the third and fourth surfaces 3 and 4 of the body 110 and respectively connected to the first and second internal electrodes 121 and 122.

In the present example embodiment, a structure is described in which the multilayer electronic component 100 has two external electrodes 130 and 140, but the number or shapes of the external electrodes 130 and 140 may be changed depending on shapes of the internal electrodes 121 and 122 or other purposes.

The external electrodes 130 and 140 may be formed of any material having electrical conductivity such as a metal, and a specific material may be determined in consideration of electrical properties, structural stability, or the like. In addition, the external 130 and 140 may have a multilayer structure.

For example, the external electrodes 130 and 140 may include electrode layers 131 and 141 disposed on the body 110, and plating layers 132 and 142 formed on the electrode layers.

As a more specific example of the electrode layer, the electrode layer may be a sintered electrode including a conductive metal and glass, or a resin-based electrode including a conductive metal and a resin.

In addition, the electrode layers 131 and 141 may have a form in which the sintered electrode and the resin-based electrode are sequentially formed on the body. In addition, the electrode layers may be formed by transferring a sheet including a conductive metal onto the body or by transferring a sheet including a conductive metal onto the sintered electrode.

A material having excellent electrical conductivity may be used as the conductive metal, included in the electrode layer, and is not limited. For example, the conductive metal may be at least one of nickel (Ni), copper (Cu), and an alloy thereof.

The plating layers 132 and 142 may serve to improve xx b. A type of the plating layers is not limited, and each of the plating layers may be a plating layer including at least one of Ni, Sn, Pd, and alloys thereof, and may be formed of a plurality of layers.

As a more specific example, each of the plating layers 132 and 142 may be a Ni plating layer or a Sn plating layer, may be a form in which the Ni plating layer and the Sn plating layer are sequentially formed on the electrode layer, or may be a form in which the Sn plating layer, the Ni plating layer, and the Sn plating layer are sequentially formed. In addition, each of the plating layers 132 and 142 may include a plurality of Ni plating layers and/or a plurality of Sn plating layers.

A size of the multilayer electronic component 100 is not limited.

However, in order to simultaneously achieve miniaturization and high capacitance, the number of laminated dielectric layers and internal electrodes may need to be reduced to increase the number of laminates, such that the multilayer electronic component 100 having a size of 0603 (length×width, 0.6 mm×0.3 mm) may have a more remarkable reliability improvement effect according to the present disclosure.

Here, a length of the multilayer electronic component 100 may refer to a maximum size of the multilayer electronic component 100 in the second direction, and a width of the multilayer electronic component 100 may refer to a maximum size of the multilayer electronic component 100 in the third direction.

Referring to FIG. 3, as a result of uneven stress applied to each of the capacitance formation portions Ac, the margin portions 114 and 115, and the cover portions 112 and 113 in the process of sintering the body, the deformation of a shape of the body portion may be intensified. Specifically, uneven stress (in a direction of the arrow in FIG. 3) occurring during the sintering and cooling processes may intensify a phenomenon in which convex shapes of the cover portions 112 and 113 and concave shapes of the margin portions 114 and 115 are formed. The intensified deformation of the cover portions 112 and 113 and the margin portions 114 and 115 may cause a crack C in a region VA in which the cover portions 112 and 113 and the margin portions 114 and 115 are in contact with each other, and thus, a defect may occur in the multilayer electronic component.

Referring to FIG. 4, the body 110 of the multilayer electronic component 100 according to an example embodiment of the present disclosure may include the internal electrodes 121 and 122 and the dummy electrodes 123 and 124 spaced apart from each other in the third direction. As the dummy electrodes 123 and 124 are spaced apart from the internal electrodes 121 and 122 in the third direction, a fraction difference between electrodes included in the capacitance formation portion Ac and the margin portions 114 and 115 may be reduced, and contraction stress applied to the margin portions 114 and 115 may be partially compensated for by delaying contraction of the margin portions 114 and 115 during firing. When the contraction stress applied to the margin portions 114 and 115 is partially compensated for, the deformation of the margin portions 114 and 115 may be reduced, and the occurrence of cracks in the region in which the cover portions 112 and 113 and the margin portions 114 and 115 are in contact with each other may be alleviated.

When the dummy electrodes 123 and 124 are included in the margin portions 114 and 115 in an excessive proportion, the dummy electrodes 123 and 124 may have excessive contraction delay or the margin portions 114 and 115 may expand. Thus, the proportion of the dummy electrodes 123 and 124 in the margin portions 114 and 115 may need to be properly adjusted.

Referring to FIG. 4, a distance in the first direction from an uppermost internal electrode in the first direction to a lowermost internal electrode in the first direction may be denoted by A, and a distance in the first direction from an uppermost dummy electrode in the first direction to a lowermost dummy electrode in the first direction may be denoted by a. In this case, when a/A is less than 0.30, the dummy electrodes 123 and 124 in the margin portions 114 and 115 may have an insufficient contraction delay effect, such that contraction stress applied to the margin portions 114 and 115 may not be sufficiently compensated for. When a/A is greater than 0.80, the dummy electrodes 123 and 124 may have excessive contraction delay, or the margin portions 114 and 115 may expand.

Accordingly, in an example embodiment of the present disclosure, when a distance in the first direction from an uppermost internal electrode in the first direction to a lowermost internal electrode in the first direction is denoted by A, and a distance in the first direction from an uppermost dummy electrode in the first direction to a lowermost dummy electrode in the first direction is denoted by a, contraction behavior of the margin portions 114 and 115 caused by the dummy electrodes 123 and 124 may be properly adjusted, thereby alleviating the occurrence of cracks at a boundary between the cover portions 112 and 113 and the margin portions 114 and 115 of the multilayer electronic component 100.

A method of measuring the distance (A) in the first direction from the uppermost internal electrode in the first direction to the lowermost internal electrode in the first direction and the distance (a) in the first direction from the uppermost dummy electrode in the first direction to the lowermost dummy electrode in the first direction is not limited.

For example, the distance (A) in the first direction from the uppermost internal electrode in the first direction to the lowermost internal electrode in the first direction may be measured by dividing the capacitance formation portion Ac, in a cross-section in the first direction and the third direction obtained by polishing the multilayer electronic component 100 up to the center of the multilayer electronic component 100 in the second direction, into multiple (e.g., seven) portions in the third direction, and calculating an average value of distances from the uppermost internal electrode in the first direction to the lowermost internal electrode in the first direction in these (e.g., five) regions except for both ends regions in the third direction, using an optical microscope (OM) or an SEM.

In addition, the distance (a) in the first direction from the uppermost dummy electrode in the first direction to the lowermost dummy electrode in the first direction may be measured by dividing margin portions 114 and 115, in the cross-section in the first direction and the third direction obtained by polishing the multilayer electronic component 100 up to the center of the multilayer electronic component 100 in the second direction, into multiple (e.g., five) portions in the third direction, and calculating an average value of distances from the uppermost dummy electrode in the first direction to the lowermost dummy electrode in the first direction in these regions except for both ends regions in the third direction, using the OM or the SEM.

Referring to FIG. 4, a minimum size in the third direction of each of the margin portions 114 and 115 may be denoted by B, and a minimum size in the third direction of each of the dummy electrodes 123 and 124 may be denoted by b. In this case, a separation distance between the dummy electrodes 123 and 124 and the internal electrodes 121 and 122 may be denoted by (B−b).

When (B−b)/B is less than 0.03, the internal electrodes 121 and 122 and the dummy electrodes 123 and 124 may come into contact with each other due to spreading during the formation of the internal electrodes 121 and 122 or the dummy electrodes 123 and 124. When (B−b)/B is greater than 0.60, the dummy electrodes 123 and 124 may have an insufficient effect of delaying the contraction of the margin portions 114 and 115.

Accordingly, in an example embodiment, (B−b)/B may be adjusted to satisfy 0.03 or more and 0.60 or less, thereby properly adjusting contraction behavior of the margin portions 114 and 115 while preventing a phenomenon in which the internal electrodes 121 and 122 and the dummy electrodes 123 and 124 are connected to each other.

A method of measuring the minimum size (B) in the third direction of each of the margin portions 114 and 115 and the maximum size (b) in the third direction of each of the dummy electrodes 123 and 124 is not limited.

For example, the minimum size (B) in the third direction of each of the margin portions 114 and 115 may be measured by calculating a minimum value of a distance in the third direction from an external surface of the margin portion to one end in the third direction of the internal electrode of the capacitance formation portion, using the OM or the SEM, in the cross-section in the first direction and the third direction obtained by polishing the multilayer electronic component 100 up to the center of the multilayer electronic component 100 in the second direction, and the maximum size (b) in the third direction of each of the dummy electrodes 123 and 124 may be measured by calculating a maximum value of a size in the third direction from one end in the third direction of each of the dummy electrodes 123 and 124 to the other end in the third direction of each of the dummy electrodes 123 and 124, using the OM or the SEM, in the cross-section in the first direction and the third direction obtained by polishing the multilayer electronic component 100 up to the center of the multilayer electronic component 100 in the second direction.

An element of the dummy electrodes 123 and 124 are not limited. However, in order to easily control a degree of contraction of the margin portions 114 and 115 and the capacitance formation portion Ac, the dummy electrodes 123 and 124 may include at least one element, the same as a conductive metal element included in the internal electrodes 121 and 122.

In an example embodiment, the dummy electrodes 123 and 124 may be disposed to be spaced apart from the external electrodes 130 and 140, thereby preventing a phenomenon in which the first external electrode 130 and the second external electrode 140 are connected to each other.

In an example embodiment, the dummy electrodes 123 and 124 may be in contact with the fifth surface 5 and the sixth surface 6, surfaces of the body 110 opposing each other in the third direction. Specifically, the first dummy electrode 123 may be in contact with the fifth surface 5, and the second dummy electrode 124 may be in contact with the sixth surface 6. Accordingly, heat generated when the multilayer electronic component 100 is operated may be effectively discharged to the outside of the multilayer electronic component 100.

In an example embodiment, the dummy electrodes 123 and 124 may be disposed on the margin portions 114 and 115. In this case, a dummy electrode disposed on the first margin portion 114 may be the first dummy electrode 123, and a dummy electrode disposed on the second margin portion 115 may be the second dummy electrode 124.

An arrangement of the first dummy electrodes 123 and 124 and the second dummy electrode 124 may be symmetrical to a straight line passing through the center of the capacitance formation portion in the first direction, as illustrated in FIG. 4, but the present disclosure is not limited thereto.

Specifically, referring to FIG. 5, a body 110-1 according to an example embodiment may include a first dummy electrode 123-1 and a second dummy electrode 124-1, the first dummy electrode 123-1 may be disposed to be biased toward one side of the body 110-1 in the first direction, and the second dummy electrode 124-1 may be disposed to be biased toward a side opposite to the one side of the body 110-1 in the first direction.

Referring to FIG. 5, a smaller value among values of a distance between the first dummy electrode 123-1 and an end of the capacitance formation portion Ac in the first direction may be denoted by D1, and a smaller value among values of a distance between the second dummy electrode 124-1 and the end of the capacitance formation portion Ac in the first direction may be denoted by D2. In this case, D1 and D2 may have substantially the same value. Accordingly, upper and lower surfaces of the multilayer electronic component 100 may not be distinguished from each other, such that a degree of freedom of mounting may be secured.

Referring to FIG. 6, a body 110-2 according to an example embodiment may include a first dummy electrode 123-2 and a second dummy electrode 124-2, and the first dummy electrode 123-2 and the second dummy electrode 124-2 may be disposed to be biased toward one side of the body 110-2 in the first direction.

The first dummy electrode 123-2 and the second dummy electrode 124-2 disposed to be biased to the one side of the body 110-2 in the first direction may mean that the first dummy electrode 123-2 and the second dummy electrode 124-2 are disposed to be closer to one of the first surface 1 and the second surface 2 of the body 110-2.

As in an example embodiment, when the first dummy electrode 123-2 and the second dummy electrode 124-2 are disposed to be biased to the one side of the body 110-3 in the first direction, a phenomenon in which a mounting surface, among a first surface 1 and a second surface 2 of the body 110-2, becomes convex may be intensively alleviated, and thus mounting stability of the multilayer electronic component 100 may be improved.

Referring to FIG. 7, a body 110-3 according to an example embodiment may include a first dummy electrode 123-3 and a second dummy electrode 124-3, and a width in the third direction of each of the dummy electrodes 123-3 and 124-3 may have a maximum value in a central portion in the first direction of a region in which the dummy electrodes are disposed. Accordingly, in a center portion in the first direction of each of the margin portions 114 and 115 in which a degree of contraction is maximized during a sintering process, a dummy electrode having a relatively large width in the third direction may be disposed, and a dummy electrode having a width in the third direction, decreasing toward both sides in the first direction of each of the margin portions 114 and 115 from the center portion in the first direction of each of the margin portions 114 and 115 may be disposed, thereby minimizing a proportion of the dummy electrodes 123-3 and 124-3 in the margin portions 114 and 115 while sufficiently controlling the contraction of the margin portions 114 and 115.

Referring to FIG. 8, a surface of the body 110′ may include a convex portion VS that is convex toward the outside of the body 110′ in the first direction and a concave portion CS that is concave toward the inside of the body 110′ in the third direction. As described above, the concave portion CS that is concave toward the inside of the body 110′ may form a surface of each of the margin portions 123 and 124, and may have a shape opposite to that of the convex portion VS formed on the surface of each of the cover portions 112 and 113.

When a/A is adjusted to satisfy 0.30 to 0.80 as in an example embodiment, the formation of the concave portion CS and the convex portion VS may be alleviated. Specifically, when a maximum width of the body 110′ in the third direction is denoted by Wmax and a minimum width of the body 110′ in the third direction is denoted by Wmin, (Wmax−Wmin)/(Wmax) may be 0.028 or less, thereby minimizing a degree of the concave portion CS and the convex portion VS being formed by the body 110′.

A method of forming the dummy electrodes 123, 123-1, 123-2, 123-3, 124, 124-1, 124-2, and 124-3 according to various example embodiments of the present disclosure is not limited. For example, referring to FIG. 9, the dummy electrodes 123 and 124 may be formed by disposing a dielectric layer 111 on which a pattern for the dummy electrodes 123 and 124 is printed between dielectric layers 111 on which the internal electrodes 121 and 122 are formed, and performing pressing and sintering processes. A thickness of the dielectric layer 111 on which the pattern for the dummy electrodes 123 and 124 is printed and a frequency in which the dielectric layer 111 is disposed between the dielectric layers 111 on which the internal electrodes 121 and 122 are formed may be adjusted, such that the dummy electrodes 123, 123-1, 123-2, 123-3, 124, 124-1, 124-2, and 124-3 according to various example embodiments of the present disclosure may be formed.

The dummy electrodes 123, 123-1, 123-2, 123-3, 124, 124-1, 124-2, and 124-3 according to various example embodiments of the present disclosure may be formed by printing a conductive paste on a ceramic green sheet, and the printing method may be a screen-printing method or a gravure-printing method, but the present disclosure is not limited thereto.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are merely used to describe a specific example embodiment, and are not intended to limit the present disclosure. Singular forms may include plural forms as well unless the context clearly indicates otherwise.

What is claimed is:

1. A multilayer electronic component comprising:
a body including a plurality of dielectric layers and a plurality of internal electrodes disposed alternately in a first direction; and
an external electrode disposed on respective surfaces of the body opposing each other in a second direction that is perpendicular to the first direction,
wherein the body includes a plurality of dummy electrodes disposed to be spaced apart from the plurality of internal electrodes in a third direction that is perpendicular to the first direction and the second direction, and
when a distance in the first direction from an uppermost internal electrode in the first direction to a lowermost internal electrode in the first direction is denoted by A, and a distance in the first direction from an uppermost dummy electrode in the first direction to a lowermost dummy electrode in the first direction is denoted by a, a/A satisfies 0.30 or more and 0.80 or less.

2. The multilayer electronic component of claim 1, wherein the plurality of internal electrodes and the plurality of dummy electrodes are not aligned with each other in the second direction or the third direction.

3. The multilayer electronic component of claim 1, wherein the plurality of internal electrodes and the plurality of dummy electrodes do not overlap each other in the second direction or the third direction.

4. The multilayer electronic component of claim 1, wherein
the body includes a capacitance formation portion, which is a region where internal electrodes in the plurality of internal electrodes overlap in the first direction, and margin portions disposed on both sides of the capacitance formation portion in the third direction, and
when a minimum size of the margin portion in the third direction is denoted by B and a maximum size of the dummy electrode in the third direction is denoted by b, (B−b)/B satisfies 0.03 or more and 0.60 or less.

5. The multilayer electronic component of claim 1, wherein
an internal electrode in the plurality of internal electrodes includes a conductive metal element, and
a dummy electrode in the plurality of dummy electrodes includes at least one element, the same as the conductive metal element included in the internal electrode.

6. The multilayer electronic component of claim 1, wherein the plurality of dummy electrodes is disposed to be spaced apart from the external electrode.

7. The multilayer electronic component of claim 1, wherein the plurality of dummy electrodes is in contact with surfaces of the body opposing each other in the third direction.

8. The multilayer electronic component of claim 1, wherein, when a region of the body in which the internal electrodes overlap each other in the first direction is a capacitance formation portion, and regions of the body, positioned on both sides of the capacitance formation portion in the third direction, are a first margin portion and a second margin portion, the plurality of dummy electrodes includes a first dummy electrode disposed on the first margin portion, and a second dummy electrode disposed on the second margin portion.

9. The multilayer electronic component of claim 8, wherein the first dummy electrode and the second dummy electrode are disposed to be biased toward one side of the body in the first direction.

10. The multilayer electronic component of claim 8, wherein the first dummy electrode is disposed to be biased toward one side of the body in the first direction, and the second dummy electrode is disposed to be biased toward a side opposite to the one side of the body in the first direction.

11. The multilayer electronic component of claim 1, wherein a width of the plurality of dummy electrodes in the third direction has a maximum value in a central portion in the first direction of a region of the body in which the plurality of dummy electrodes is disposed.

12. The multilayer electronic component of claim 1, wherein, when a maximum width of the body in the third direction is denoted by Wmax and a minimum width of the body in the third direction is denoted by Wmin, (Wmax−Wmin)/Wmax satisfies 0.028 or less.

13. The multilayer electronic component of claim 1, wherein a surface of the body includes a convex portion that is convex toward an outside of the body in the first direction, and a concave portion that is concave toward an inside of the body in the third direction.

14. The multilayer electronic component of claim 1, wherein
the body includes a capacitance formation portion and first and second margin portions disposed on both sides of the capacitance formation portion in the third direction, wherein the capacitance formation portion is a portion where internal electrodes in the plurality of internal electrodes overlap in the first direction,
the plurality of dummy electrodes includes a plurality of first dummy electrodes disposed in the first margin portion and a plurality of second dummy electrodes disposed in the second margin portion,
a distance in the first direction from an uppermost first dummy electrode to an upper end of capacitance formation portion is smaller than a distance in the first direction from a lowermost first dummy electrode to a lower end of capacitance formation portion, and
a distance in the first direction from a lowermost second dummy electrode to a lower end of capacitance formation portion is smaller than a distance in the first direction from an uppermost second dummy electrode to an upper end of capacitance formation portion.

15. The multilayer electronic component of claim 14, wherein
the distance in the first direction from the uppermost first dummy electrode to the upper end of capacitance formation portion is substantially the same as the distance in the first direction from the lowermost second dummy electrode to the lower end of capacitance formation portion.

16. The multilayer electronic component of claim 15, wherein
the distance in the first direction from the lowermost first dummy electrode to the lower end of capacitance formation portion is substantially the same as the distance in the first direction from the uppermost second dummy electrode to the upper end of capacitance formation portion.

17. The multilayer electronic component of claim 1, wherein
the body includes a capacitance formation portion and first and second margin portions disposed on both sides of the capacitance formation portion in the third direction, wherein the capacitance formation portion is a portion where internal electrodes in the plurality of internal electrodes overlap in the first direction,
the plurality of dummy electrodes includes a plurality of first dummy electrodes disposed in the first margin portion and a plurality of second dummy electrodes disposed in the second margin portion,
a width of an uppermost first dummy electrode and a width of a lowermost first dummy electrode in the third direction are smaller than a width of a first dummy electrode between the uppermost and lowermost first dummy electrodes in the third direction, and
a width of an uppermost second dummy electrode and a width of a lowermost second dummy electrode in the third direction are smaller than a width of a second dummy electrode between the uppermost and lowermost second dummy electrodes in the third direction.

18. The multilayer electronic component of claim 17, wherein
the width of the uppermost first dummy electrode and the width of the lowermost first dummy electrode in the third direction are substantially the same as each other, and the width of the uppermost second dummy electrode and the width of the lowermost second dummy electrode in the third direction are substantially the same as each other.
